(19) United States
(12) Patent Application Publication
(10) Pub. No.: US 2020/0304603 A1
(43) Pub. Date: Sep. 24, 2020

(54) ADJUSTING A PROTOCOL FOR A CONCRETE APPLIANCE

(71) Applicant: FIRMITAS CYBER SOLUTIONS (ISRAEL) LTD., Kfar Saba (IL)

(72) Inventors: Gil KEINI, Nirit (IL); Rami SHAFT, Rehovot (IL)

(73) Assignee: FIRMITAS CYBER SOLUTIONS (ISRAEL) LTD., Kfar Saba (IL)

(21) Appl. No.: 16/087,734

(22) PCT Filed: Mar. 21, 2017
(86) PCT No.: PCT/IL2017/050353

§ 371 Date: Sep. 24, 2018

Related U.S. Application Data
(60) Provisional application No. 62/311,943, filed on Mar. 23, 2016.

(51) Int. Cl. H04L 29/06

(52) U.S. Cl. CPC H04L 69/03; H04L 63/20; H04L 63/1408; H04L 69/18; H04L 63/1441

(57) ABSTRACT

A method, a computerized apparatus and a computer program product for adjusting a protocol for a concrete appliance. The method comprises: obtaining a protocol, wherein the protocol is a user-defined communication protocol, wherein the protocol is utilized by a generic appliance; obtaining a specification of a concrete appliance, wherein the specification is a computer-readable specification, wherein the concrete appliance is a concretization of the generic appliance, wherein the specification indicates one or more limitations of the concrete appliance which are not generic limitations applicable to the generic appliance; and modifying the protocol based on the specification, whereby adjusting the protocol to comply with the one or more limitations of the concrete appliance.

### CROSS-REFERENCE TO RELATED APPLICATION

This application claims the benefit of U.S. Provisional Application No. 62/311,943 filed Mar. 23, 2016, entitled “Systems and Methods for Protocol Enforcement and Cyber Security”, which is hereby incorporated by reference in its entirety.

### TECHNICAL FIELD

The present disclosure relates to communication protocols in general, and to communication protocols adjustment for concrete appliance, in particular.

### BACKGROUND

Computerized devices and systems control almost every aspect of our life, especially in industry. In order to provide the required services or supply, modern factories, utility providers and other sites need and use tens to tens of thousands of computerized devices, connected in one or more networks.

Each such device may be regarded as a Computer Based Appliance, also referred to as a device or as an appliance, having processor such as a CPU and a communication interface. Some devices comprise controllers for controlling machines such as engines, turbines, or the like. In some situations, the network may also comprise one or more virtual appliances, and possibly additional components. Any device within the network may be configured for receiving and/or transmitting communication, for example to or from other devices within the network.

In some exemplary embodiments, the appliance may be implemented using a virtual machine. A virtual machine may be an emulated computer that, like a physical computer, is capable of executing an operating system and applications. A virtual machine may be an operating system (OS) or application environment that is installed on software, which imitates dedicated hardware. The end user may have the same experience on a virtual machine as she would have on dedicated hardware.

Yet another kind of appliances may be computer appliances. Computer appliances may be computing devices with a specific function and limited configuration ability, such as storage appliances that provide storage functionality for multiple attached systems using the transparent local storage area networks paradigm, Firewall- and Security appliances designed to protect computer networks from unwanted traffic, Anti-spam appliances used for preventing e-mail spam, network appliances such as general purpose routers, or the like.

Appliances may be networked together, to combine their controls and key functions. In some cases, the appliances may share information, synchronize their operation, implement event-based logic, or the like. The devices within the network may communicate using any common or proprietary communication protocol, in which messages are transmitted over any of communication infrastructure. The messages may include commands, instructions, data, or the like. Some of the devices may have connection to computing platforms external to the network, such as an Internet connection, while others may communicate only with devices from within the network.

### BRIEF SUMMARY

One exemplary embodiment of the disclosed subject matter is a computer-implemented method comprising: obtaining a protocol, wherein the protocol is a user-defined communication protocol, wherein the protocol is utilized by a generic appliance; obtaining a specification of a concrete appliance, wherein the specification is computer-readable specification, wherein the concrete appliance is a concretization of the generic appliance, wherein the specification indicates one or more limitations of the concrete appliance which are not generic limitations applicable to the generic appliance; and modifying the protocol based on the specification, whereby adjusting the protocol to comply with the one or more limitations of the concrete appliance.

Optionally, said modifying comprises: restricting values of one or more fields within a message in accordance with the specification.

Optionally, said restricting values comprises restricting values that are not supported by the concrete appliance.

Optionally, said restricting values comprises restricting values that are supported by the concrete appliance and are indicated by the specification as not recommended.

Optionally, said modifying comprises: enforcing a maximal rate of messages.

Optionally, the one or more limitations comprise a limitation of the concrete appliance to perform actions in response to the messages, wherein the maximal rate of messages is defined based on the limitation, wherein the limitation is based on a physical limitation of the concrete appliance on a rate of the actions.

Optionally, the one or more limitations comprise a limitation of the concrete appliance on a rate of receiving or processing messages, wherein the maximal rate of messages is defined based on the limitation.

Optionally, said modifying comprises: enforcing a minimal delay between two messages.

Optionally, the one or more limitations comprise a pre-condition on a state of the concrete appliance, wherein a processing of a message, by the concrete appliance, is conditioned on the pre-condition, wherein said modifying comprises: enforcing the pre-condition.

Optionally, the concrete appliance is configured to be deployed in an environment in which communication messages are transmitted to or from the concrete appliance based on the protocol.

Optionally, the method further comprising: enforcing, in a deployment environment, the modified protocol, wherein the deployment environment comprises the concrete appliance.

Optionally, said enforcing comprises: generating a new message to comply with a minimal frequency requirement indicated in the specification.

Optionally, the method 1 further comprises defining a modification action to modify a message that complies with the protocol and does not comply with the modified protocol.

Another exemplary embodiment of the disclosed subject matter is a computerized apparatus having a processor, the processor being adapted to perform the steps of: obtaining a protocol, wherein the protocol is a user-defined communication protocol, wherein the protocol is utilized by a generic appliance; obtaining a specification of a concrete appliance, wherein the specification is computer-readable specification, wherein the concrete appliance is a concretization of the generic appliance, wherein the specification indicates one or more limitations of the concrete appliance which are not generic limitations applicable to the generic appliance; and modifying the protocol based on the specification, whereby adjusting the protocol to comply with the one or more limitations of the concrete appliance.

Yet another exemplary embodiment of the disclosed subject matter is a computer program product comprising a non-transitory computer readable storage medium retaining program instructions, which program instructions when read by a processor, cause the processor to perform a method comprising: obtaining a protocol, wherein the protocol is a user-defined communication protocol, wherein the protocol is utilized by a generic appliance; obtaining a specification of a concrete appliance, wherein the specification is computer-readable specification, wherein the concrete appliance is a concretization of the generic appliance, wherein the specification indicates one or more limitations of the concrete appliance which are not generic limitations applicable to the generic appliance; and modifying the protocol based on the specification, whereby adjusting the protocol to comply with the one or more limitations of the concrete appliance.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of an exemplary environment and architecture in which the disclosed subject matter may be utilized, in accordance with some exemplary embodiments of the disclosed subject matter;

FIG. 2 shows a flowchart diagram of a method, in accordance with some exemplary embodiments of the disclosed subject matter; and

FIGS. 3A-3C show schematic block diagrams of embodiments of locating rule enforcement module relative to source device, in accordance with some exemplary embodiments of the disclosed subject matter;

### DETAILED DESCRIPTION

One technical problem dealt with by the disclosed subject matter is to adjust communications protocol utilized by generic appliances, to comply with the limitation of concrete appliances. In some exemplary embodiments, the concrete appliances may be concretizations of the generic appliances.

In some exemplary embodiments, a network of appliances may communicate in accordance with a communication model. The communication model may define communication protocols utilized by each appliance, relationships between protocols, messages over the same or different protocols, or the like. A communication protocol may be a system of rules that allow to transmit information, commands, messages or the like between two or more entities. The rules may define the syntax, semantics, synchronization, or the like of the communication and possible error recovery methods.

In some exemplary embodiments, the communication protocol may be suitable for use by a generic appliance. For example, the generic appliance may be a phone set which utilizes Signaling System No. 7 (SS7) protocol. The concrete appliance may be a phone set of a specific model that is offered by a LG™, a phone set of a specific model that is offered by PANASONIC™, or the like. As another example, an industrial oven may be configured to utilize a protocol. The industrial oven may be a generic abstraction of specific, concrete embodiments thereof, such as industrial ovens supplied by different vendors. As yet another example, the generic appliance may be a furnace configured to utilize a Modbus protocol. The Modbus protocol is a serial communications protocol. Wikipedia explains that as Modbus is simple and robust, it has become a de facto standard communication protocol, and it is a commonly available means of connecting industrial electronic devices. The main reasons for the use of Modbus in the industrial environment, according to Wikipedia, are: developed with industrial applications in mind, openly published and royalty-free, easy to deploy and maintain and moves raw bits or words without placing many restrictions on vendors. Modbus enables communication among many devices connected to the same network, for example a system that measures temperature and humidity and communicates the results to a computer. Modbus is often used to connect a supervisory computer with a remote terminal unit (RTU) in supervisory control and data acquisition (SCADA) systems. Each manufacturer may elect a different set of registers for to be used for its furnace. Once registers are assigned meaning, they can also be assigned an allowed set of values. The set of values may differ from model to model. In some cases the communication protocol may be device-agnostic. The device-agnostic communication protocol may set and read registers with no pre-defined semantics. In some cases, the communication protocol may initially assume one set of mapping between registers and meanings, and the specification of the concrete appliance may be used to verify the mapping or modify it. In some cases, the specification may be used for limiting the set of values based on limitation of the concrete appliance. As an example, some furnaces put the data related to temperature sensor in register #042, and accordingly, the communication protocol for the generic furnace may include such requirement. However, in a concrete furnace, the data may be stored in a different register, or additional data may be available, such as in case two temperature sensors are included in the concrete furnace. In some cases, the manufacturer of a device may assign semantics and impose limitations on the value of the registers in the Modbus protocol (e.g., oven temperature in register 6, pump pressure in register 28, or the like). The limitations may be imposed on all devices of this type produced by the manufacturer and some models may impose additional restrictions or use additional registers to further extend or modify the protocol, so as to support their functionality. Additionally or alternatively, the limitations may be imposed unanimously over all devices by the same manufacturer, even though some functionalities are not supported by some models of devices. In some cases, the specific device in-question, when installed at a specific environment and used in a specific manner may lead to further restrictions of the allowed communication messages.

The concrete appliance may utilize a subset or a modification of the communication protocol. In some cases, the particular embodiment of the concrete appliance may impose limitations on its ability to utilize the generic form of the communication protocol.

Additionally or alternatively, some concrete appliances may not support or may not handle well all possible values in the communication protocol. In some exemplary embodiments, the communication protocol may be a generic protocol, allowing a wide range of values in a certain field, while the concrete appliance may support a limited range of values for the same field. In some exemplary embodiments, the wide range of values may be allowed deliberately in the communication protocol designed to be utilized by the generic appliance, on purpose to support multiple appliances with wide-ranging capabilities. Additionally or alternatively, the wide range of values may be allowed deliberately to support potential improvements in the future. The protocol may support values which may not be supported by any currently-available concrete appliances, but which may be supported in the future.

In some cases, the concrete appliance may support some values, but such values may not be recommended. The not-recommended values may be not-recommended overall. Additionally or alternatively, the not-recommended values may not be recommended due to a specific deployment. The environment in which the concrete appliance is deployed, including the materials the concrete appliance may physically process and other appliances connected thereto, may affect the recommended setting for the concrete appliance. As a result, some values, which may be supported by the concrete appliance, may not be recommended.

In some exemplary embodiments, in an environment where the concrete appliance is deployed, the communication protocol may need adjustment to adhere to the limitations of the concrete appliance.

One technical solution is to modify the communication protocol based a specification of the concrete appliance. In some exemplary embodiments, the specification of the concrete appliance may be a computer-readable specification. The specification may describe, explicitly or implicitly, features of the concrete appliance. The specification may describe, explicitly or implicitly, limitations of the concrete appliance with respect to the generic appliance. The specification may describe, explicitly or implicitly, limitations of the concrete appliance with respect to the communication protocol. The specification may describe, explicitly or implicitly, messages or instructions that are supported or unsupported by the concrete appliance. The specification may describe, explicitly or implicitly, recommend and not-recommended settings and configuration of the concrete appliance. The specification may describe, explicitly or implicitly, a subset of the communication protocol supported by the concrete appliance. In some exemplary embodiments, the specification may indicate, explicitly or implicitly, one or more limitations of the concrete appliance which are not generic limitations applicable to the generic appliance. The communication protocol may be adjusted to comply with the one or more limitations of the concrete appliance.

As a non-limiting example, the one or more limitations may comprise a pre-condition on a state of the concrete appliance. A processing of a message by the concrete appliance may be conditioned on the pre-condition. The communication protocol may be adjusted to enforce the pre-condition, i.e., processing the message only if the pre-condition applies. For example, the appliance may be a Blast-Furnace in a steel plant, used for melting to produce industrial metals, such as iron, lead, copper, or the like. The communication protocol designed for generic heating appliances may comprise a cooling command message, a shutdown message, or the like, that are configured to cause the appliance to cooldown (hereinafter: cooling command). In the concrete appliance of Blast-Furnace, a cooling command may not be allowed when the Furnace is filled with molten steel, as cooling the Furnace with molten steel in it, may cause the steel to solidify and may permanently damage the Furnace. The pre-condition in this case may be the Blast-Furnace being empty, as a pre-condition to a cooling command.

In some exemplary embodiments, the communication protocol may be modified to restrict values of one or more fields within a message in accordance with the specification. Restricting the values may comprise restricting values that are not supported by the concrete appliance. As an example, a controller may be configured to operate a turbine appliance. The turbine appliance may comprise a rotor. The appliance may receive messages influencing its activity, such as setting the rotor speed. In some cases, the communication protocol standard may allow the speed field to be any integer value of 16 bit (INT16), such as any number between −32,768 and +32,767. Positive values of the speed may indicate clockwise rotation, and negative values may indicate anticlockwise rotations of the rotor. However, the concrete turbine appliance may be able to handle only positive values of the rotor speed (i.e., clockwise rotations). Such a limitation may be provided in the specification of the turbine. The communication protocol may be modified to enforce a lower limit of 0 on the speed value. The lower limit may be enforced such as by preventing commands with a negative value from being transmitted, inverting negative values to respective positive values, or the like.

Additionally or alternatively, the specification of the concrete turbine may include a limitation on the maximal value of the speed. The communication protocol may be modified to enforce a maximal value of the rotor speed accordingly. In some exemplary embodiments, a maximal absolute value of the rotor speed may be enforced, or the like.

Additionally or alternatively, a concrete turbine appliance may handle the INT16 value of the rotor speed as a positive value between 0 and 65,535. Assuming the generic protocol limits the rotor speed to be between −10,000 and +10,000 and the concrete turbine appliance is capable of handling rotor speed of up to +10,000, the different representation of the INT16 may require the restriction of certain values that may be viewed as negative values and which may be handled as large positive values if received by the concrete turbine appliance.

Additionally or alternatively, restricting the values may comprise restricting values that are supported by the concrete appliance and are indicated by the specification as not recommended. Referring to the turbine appliance example, rotor may be designed to handle speeds up to 10,000 Revolutions Per Meter (RPM). However, it may be recommended not to exceed 5,000 RPM. The recommendation may be, for example, due to accelerated mechanical wear which may be caused in higher RPM values. Additionally or alternatively, the recommendation may be based on manufacturer recommendations, based on third-party reviews of the appliance, based on engineer analysis, or the like. In some cases, the recommendation may be applicable to the deployment of the turbine appliance, such as an open-air deployment, deployment next to additional devices that may be affected by the movement of the rotor, or the like.

In some exemplary embodiments, the specification may comprise a limitation of the concrete appliance to perform actions in response to the messages being transmitted thereto. The limitation may be based on a physical limitation of the concrete appliance on the rate of the actions. In some cases, a certain action may be performed up to a certain rate, because of the physical limitation. A maximal rate of messages may be defined based on the limitation. In such a case, the communication protocol may be modified to enforce the maximal rate of messages. Referring again to the Blast-Furnace appliance example, the furnace may be heated or cooled-down in a certain rate, due to physical limitations of the appliance. Cooling-down too quickly may cause physical damages to the furnace, due to material contraction leading to cracks in the furnace. Additionally or alternatively, the cooling-down rate may be affected by the substance that is being heated by the furnace. The communication protocol may be modified to enforce a maximal rate of transmitting cooling messages so as to comply with this limitation of the Blast-Furnace appliance.

Additionally or alternatively, the specification may comprise a limitation of the concrete appliance on a rate of receiving or processing messages. The concrete appliance may be configured to process a limited number of messages within a specified period. Transmitting messages to the concrete appliance in higher rate may lead to flooding the concrete appliance with superfluous requests, overloading systems of the concrete appliance, preventing some or all legitimate messages from being processed, or the like. In some cases, transmitting messages in a rate exceeding the threshold may be part of a Denial of service (DoS) attack on the concrete appliance. The maximal rate of messages may be defined based on the limitation on the rate of receiving or processing messages, and enforced by modifying the communication protocol accordingly.

In some exemplary embodiments, modifying the communication protocol may comprise enforcing a minimal delay between two messages. In some cases, the specification of the concrete appliance may indicate operations that require a minimal timeframe therebetween in order to be performed in concatenation. A delay may be required between sending a message commanding the concrete appliance to perform the first action, and a message commanding the concrete appliance to perform the second action. As an example, assuming the concrete appliance is a system comprised of a water-tank, a drain mechanism, and a filling mechanism. A drain command may be configured to cause the appliance to drain all water from the tank, in a time-based logic (e.g., once in time frame), or to fill the tank again with water between flushes. A minimal delay between two drain commands may be required to allow re-filling the tank with water. The minimal delay may be determined based on the size of the tank of the concrete appliance, and the time required to fill it with water. The minimal delay me differ between different appliances. As another example, the concrete appliance may be a compressor of an Air Conditioning (A/C) unit. The compressor may require a time delay between switching from different modes (e.g., from cooling to heating), between turning on and turning off, or the like. The specification may indicate such limitation, and the communication protocol may be modified accordingly. In some cases, an enforcement rule may be defined to block a message that is transmitted too early. Additionally or alternatively, the enforcement rule may delay passing of the message until the required minimal delay may elapse.

In some exemplary embodiments, the concrete appliance may, in general or in a certain deployment, may expect to receive a message periodically. A minimal frequency requirement may indicate a minimal expected frequency of messages in general, or of a certain type. For example, a cache memory may be required to be cleared once a day. Similarly, a water tank may require flushing at least once an hour, an appliance may require a reboot on a bi-weekly basis, or the like.

The specification may be provided by a vendor of the concrete appliance, by a third-party, or the like. In some exemplary embodiments, the specification may be provided by an engineer involved in the deployment of the concrete appliance. Additionally or alternatively, the specification may be crowd-sourced from a community of users. Additional sources for computer-readable specification may also be available, as would be apparent to a person of ordinary skill in the art in view of the present disclosure.

In some exemplary embodiments, the modified protocol may be enforced in the deployment environment comprising the concrete appliance. The modified protocol may be enforced by dropping or correcting messages that do not comply with the modified protocol, also referred to as a violating message or an offending message. Additionally or alternatively, in order to enforce the modified protocol, a new message may be generated to comply with a minimal frequency requirement indicated in the specification. In some exemplary embodiments, a new message may be generated to notify a sender of an error. Additionally or alternatively, the new message may be generated so as to cause the sender to believe that the message was received and properly processed (e.g., ACK message). Fooling the sender may be performed when it is estimated that the violating message is caused by a malicious user attempting to exploit a vulnerability.

In some exemplary embodiments, a modification action may be defined to modify a message that complies with the protocol and does not comply with the modified protocol. The modification action may be configured to modify messages based on the modification on the communication protocol.

One technical effect of utilizing the disclosed subject matter is to provide for an automatic manner of altering a communication protocol for a given deployment. In some cases, the modified communication protocol may be enforced and as a result, potential harmful conditions may be avoided. In some cases, potential malicious activity may be mitigated, and vulnerabilities, which may be caused by known limitations of concrete appliances, may not be exploited. In some cases, non-recommended modes of operation or modes of operation that may result in physical damage to the appliance or the environment in which it is deployed, may be prevented.

Utilizing the disclosed subject matter may further prevent potentially harmful conditions from taking place. Such conditions that may be harmful for the appliance or to another resource, may be recognized based on the specification. The communication protocol may be modified based on the specification. The modified communication protocol may be enforced, such as by rule enforcement module, by alerting, dropping existing messages, creating new messages, delaying delivery of messages, or the like. Such rule enforcement may mitigate the chances of vulnerability being exploited. Such rule enforcement may mitigate the risk of undesired behavior that may be potentially harmful to the deployed environment. Specifically, potentially harmful conditions in industrial environments may be prevented.

Another technical effect of utilizing the disclosed subject matter is to prevent from cyberattacks on critical infrastructures. Sophisticated attackers may use spear-phishing and social engineering to gain access to communication protocols of appliances in an organization's production network. As an example, the attackers may attack the steel plant, prevent the plant from appropriately shutting down a blast furnace, leaving it in an undetermined state. By utilizing the disclosed subject matter, an additional layer of protection may be provided for the communication protocol, and malicious messages may be prevented from being transmitted.

Yet another technical effect may be enabling re-use of generic protocols and adapting them automatically to a concrete deployment. In some cases, the same generic protocol may be modified differently for two or more different concrete appliances, which may be deployed in the same environment.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

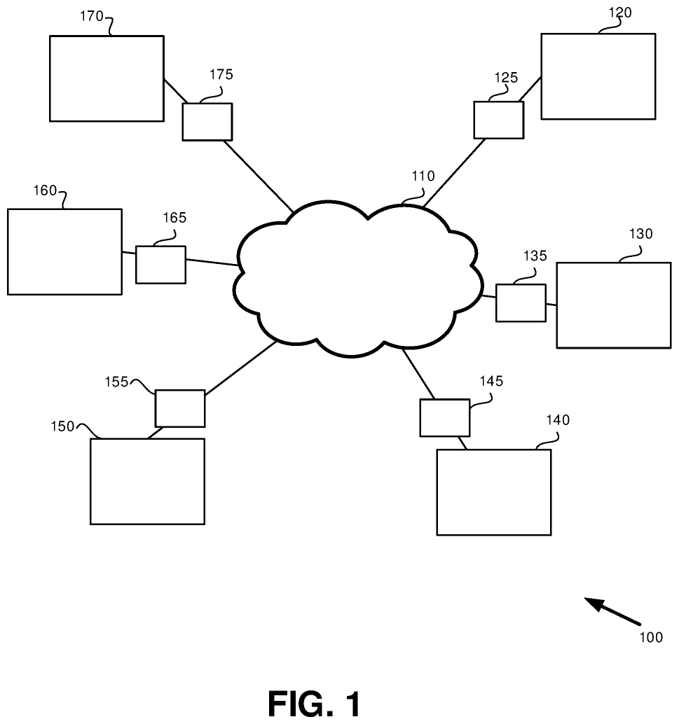

Referring now to FIG. 1 showing a schematic illustration of an exemplary environment and architecture in which the disclosed subject matter may be utilized, in accordance with some exemplary embodiments of the disclosed subject matter.

In some exemplary embodiments, an Environment 100 may be a deployment environment in which appliances are deployed. As an example, Environment 100 may be a part of plant. The plant may comprise different appliances, such as Furnaces 120, 130, 170 and Ventilators 140, 150, 160.

The deployment environment depicted in the figure illustrates the logical relationship between different components of the plant. The illustration may or may not indicate the physical location of the components. The physical location of each component may be of importance in some embodiments and physical proximity of components may be indicated in a deployment description of Environment 100. As an example, Furnace 120, Ventilator 140 and Ventilator 150, may be located in the same room in the plant, while Furnace 170 may be located in a different remote room than Furnace 120. Such information may be electronically available in a deployment description data. In some cases, the deployment description data may indicate precise location of components. Additionally or alternatively, the deployment description data may indicate proximate absolute location of component. Additionally or alternatively, the deployment description data may indicate relative location to other components (e.g., 5 meters from component X) or locations (e.g., within room 101).

In some exemplary embodiments, some of the appliances in Environment 100 may physically process materials (not shown). For example, Furnace 120 may heat an item. The deployment description data may indicate the materials.

In some exemplary embodiments, Furnaces 120, 130, 170 an Ventilators 140, 150, 160 may be connected to each other via a Network 110. The appliances may communicate in accordance with a communication model. The communication model may be user-defined. Additionally or alternatively, the communication model may be a standard model provided by a third party. The communication model may define communication protocols utilized by each appliance. The communication protocols may be common protocols, protocols in accordance with industry standards, proprietary protocols, or the like. Each appliance may transmit and receive communication messages to and from the other appliances via Network 110. The appliances may communicate based on a communication protocol of each appliance. The messages may include commands, instructions, data, or the like.

In some exemplary embodiments, the communication model may be applicable to generic appliances. The deployed appliances in Environment 100 may be concrete appliances, which are concretizations of the generic appliances. In some exemplary embodiments, the communication protocol may be adjusted to comply with the limitation of concrete appliances. For example, the generic appliance which Furnace 120 is a concretization thereof, may be a generic industrial furnace, which utilizes a generic communication protocol. Furnace 120 may be a melting furnace 5 located at factory F, which is a concrete embodiment of the generic industrial furnace, using a subset of the messages that are supported by the generic communication protocol.

In some exemplary embodiments, the concrete appliances may utilize a subset or a modification of the communication protocol of their respective generic appliance. In some cases, the particular embodiment of the concrete appliance may impose limitations on its ability to utilize the generic form of the communication protocol. Additionally or alternatively, some concrete appliances may not support or may not handle well all possible values in the communication protocol. Additionally or alternatively, the communication protocol of the generic appliance may need adjustment to adhere to the limitations of Environment 100, such as limitations of the electricity consumption of the plant, compatibility between the different appliances, or the like. The limitations may be explicitly or implicitly indicated in a computer-readable specification. The specification may be also include deployment description data.

In some exemplary embodiments, different appliances deployed in Environment 100 may be different concrete appliances of the same generic appliance. As an example, Furnace 120 and Furnace 170 may be two different concrete furnaces of the generic industrial furnace. Furnace 120 may be a melting furnace and Furnace 170 may be an annealing furnace. Additionally or alternatively, Furnace 120 and Furnace 170 may be supplied by different vendors, may have different functionalities, may perform different actions, may be deployed in different conditions, or the like. Thus, Furnace 120 and Furnace 170 may be associated with different specifications describing potentially different limitations.

Additionally or alternatively, different appliances may be the same concrete appliance of a single generic appliance. As an example, Furnace 120 and Furnace 130 may be both melting furnaces supplied by the same vendor. In some exemplary embodiments, the same concrete appliances may require different modification on the generic communication protocol, due to different recommendations. The different recommendations may be a result of different deployment manner. As an example, Furnace 120 may be used to melt gold, while Furnace 130 may be used to melt copper. The different materials that Furnace 120 and Furnace 130 physically process, may affect the recommended setting for each concrete appliance. As a result, some value, communication rules, commands, or the like, which may be supported by both of Furnace 120 and Furnace 130, may not be recommended for one of them. As an example, concrete appliances of melting furnaces may support up to 1,800° C. heating temperatures. However, for energy saving matters, the recommended maximal heating temperature for Furnace 120 may be 1,064° C. as the melting temperature of gold, and the recommended maximal heating temperature for Furnace 130 may be 1,085° C. as the melting temperature of copper.

In some exemplary embodiments, the imposed limitations of an appliance, regardless of their source and reason, may be described in a specification of the appliance. The specification may be used to adjust the communication protocols used by the appliance to adhere to the imposed limitations.

In some exemplary embodiments, a rule enforcer such as Components 125, 135, 145, 155, 165, 175, may be configured to verify that communications of the various appliances (120, 130, 140, 150, 160 and 170, respectively), comply with specification of each appliance. The rule enforcer may be a software module running on a dedicated computer. Additionally or alternatively, the rule enforcer may be run as an additional process or virtual machine on existing hardware, such as on the connection to Network 110. Additionally or alternatively, the rule enforcer may be an internal component of the appliance. Additionally or alternatively, the rule enforcer may be a dedicated hardware component. Additionally or alternatively, a centralized rule enforcer (not shown) may be implemented instead of or in addition to the distributed rule enforcers depicted in FIG. 1. The centralized rule enforcer may monitor and potentially intercept and modify each message transmitted in Network 110.

In some exemplary embodiments, the rule enforcer may be configured to enforce the modified protocol in Environment 110. In some exemplary embodiments, the rule enforcer may be configured to perform a responsive action in response to an offending message. The rule enforcer may correct messages that do not comply with the modified protocol, prevent violating or offending messages from being transmitted, or the like. Additionally or alternatively, the rule enforcer may generate new messages, such as in order to comply with a minimal frequency requirement indicated in the specification, to communicate with the device sending the offending message, or the like. In some exemplary embodiments, the responsive action may be configured to comply with a state machine defined by the modified protocol. The responsive action may be to generate a new message instead of the offending message so as to comply with the state machine. Additionally or alternatively, the responsive action may be to send a response message in accordance with the state machine, such as a message notifying that the offending message is ignored.

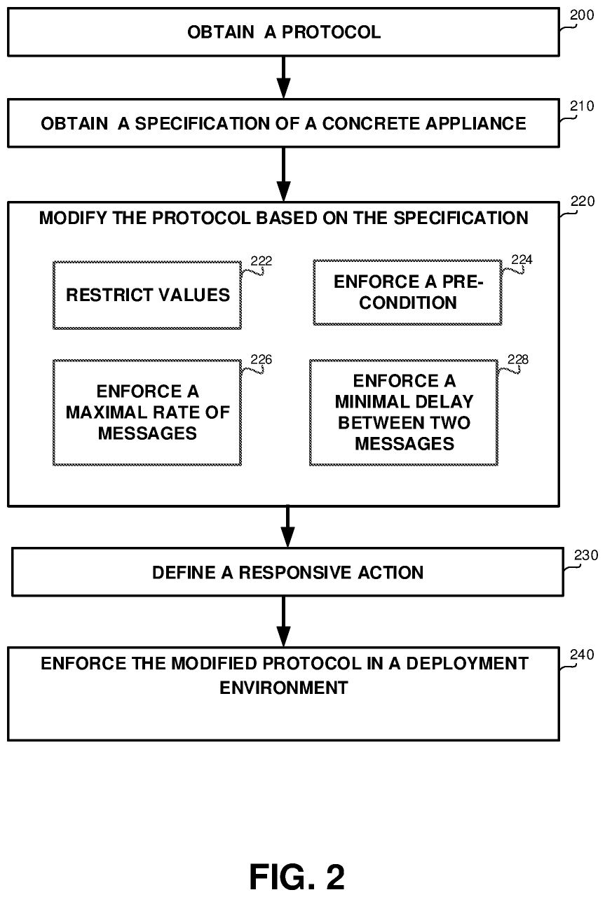

Referring now to FIG. 2 showing a flowchart diagram of a method, in accordance with some exemplary embodiments of the subject matter.

On Step 200, a protocol may be obtained. In some exemplary embodiments, the protocol may be a user-defined communication protocol. A generic appliance may utilize the protocol. The protocol may allow the generic appliance to communicate with other devices, by transmitting messages over a communication infrastructure. In some cases, the protocol may be comprised by a communication model.

On Step 210, a specification of a concrete appliance may be obtained. The specification may be a computer-readable specification. The concrete appliance may be a concretization of the generic appliance. The concrete appliance may be configured to be deployed in an environment in which communication messages are transmitted to or from the concrete appliance based on the protocol. The messages may include commands, instructions, data, or the like.

In some exemplary embodiments, the specification may indicate one or more limitations of the concrete appliance that are not generic limitations applicable to the generic appliance. As an example, the communication protocol may define a generic range of operating temperatures that are applicable to the generic appliance, while the specification may define a recommended sub-range of operating temperatures that is relevant for the concrete appliance.

In some exemplary embodiments, the specification may include limitations caused by a specific deployment, such as a manner of installation, mode of operation, physical location of the concrete device and potentially other devices in the environment, devices connected to or in communication with the concrete appliance, inputs, such as substances and materials, provided to the concrete appliance, or the like.

On Step 220, the protocol may be modified based on the specification. In some cases, a modified protocol may be created by modifying the definitions of the protocol. By modifying the protocol, the protocol may be adjusted to comply with the one or more limitations of the concrete appliance. In some exemplary embodiments, the protocol may be modified by a rule enforcer in accordance with the specification of the appliance to which the rule enforcer is associated. Additionally or alternatively, the protocol may be modified by a computerized device, such as a server, performing pre-processing of a communication protocol or communication model. In some cases, the server may pre-process user-defined communication model and may adjust the user-defined communication model to adhere to a specific deployment. In some exemplary embodiments, modified communication model may be transmitted to rule enforcer for enforcement. Additionally or alternatively, based on the modified communication model digital rules may be generated and provided to a rule enforcer for enforcement. Additionally or alternatively, based on the modified communication model, computer instructions for enforcing the model may be generated. The computer instructions may form a computer program product that is executed by a processor to implement the rule enforcer.

In some exemplary embodiments, messages transmitted to the concrete appliance may comprise fields or variables that different values may be assigned to. As an example, some messages may comprise integer values that may be assigned to any value between −32,768 and +32,768, other messages may comprise integer values of two digits only, i.e. −99 to +99, or the like. The specification may indicate limitations on the values of the fields. As an example, a specification of an air condition appliance may limit the two digits numerical value of a valid temperature be between 16 and 30.

On Step 222, values of one or more fields within a message in accordance with the specification may be restricted. The values may be restricted to comply with the limitations on the values. Values that are not supported by the concrete appliance may be restricted.

Additionally or alternatively, values that are supported by the concrete appliance and are indicated by the specification as not recommended may be restricted. As an example, a specification of a washing machine may allow a maximum spin speed of up to 2000 RPM. However, a lower spin speed may be recommended to prevent harming delicate fabrics being washed by the washing machine. Values of the spin speed may be restricted based on specification not to exceed 1000 RPM.

On Step 224, a pre-condition may be enforced. In some exemplary embodiments, the one or more limitations may comprise a pre-condition on a state of the concrete appliance. A processing of a message, by the concrete appliance, may be conditioned on the pre-condition. The message may be processed and the resulted operation of the message may be carried out, only if the pre-condition applies.

As an example, a command to increase the concrete appliance internal pressure may or may not be permissible, depending on the appliance's current cumulative pressure. Increasing the internal pressure may be permitted only if current cumulative pressure has not reached its maximal value as defined by a vendor of the concrete appliance or system engineer in the specification. In some cases, an increase pressure message instructing to increase the pressure by an increment may be allowed if the cumulative pressure after the increment is added does not exceed a threshold.

As an additional example, a command to move right X degrees (such as, for example, 5 degrees, 10 degrees, 15 degrees or the like) of a gun turret, may be allowed based on the communication protocol. However, the command may be allowed up to a certain cumulative value. The cumulative value may be dictated by a physical limitation of the gun torrent's maximal and minimal angles.

On Step 226, a rate of messages may be enforced. In some exemplary embodiments, the one or more limitations may comprise a limitation of the concrete appliance to perform actions in response to the messages. The maximal rate of messages may be defined based on this limitation. The limitation may be based on a physical limitation of the concrete appliance on the rate of the actions. Additionally or alternatively, the one or more limitations may comprise a limitation of the concrete appliance on a rate of receiving or processing messages. Additionally or alternatively, the limitation may be a minimal frequency requirement, which may induce a limitation on a minimal rate of messages issued by the concrete appliance or received thereby.

On Step 228, a minimal delay between two messages may be enforced.

On Step 230, a responsive action may be defined. The responsive action may be configured to be invoked when the modified protocol is violated. The responsive action may be an action which drops offending messages. The responsive action may be a modification action, which modifies an offending message. The offending message may be a message that complies with the original, unmodified, protocol but violates the modified protocol. The modification may change the content of the offending message so as to render it in accordance with the modified protocol. The modification action may modify a sequence of messages, such as enforce an ordering defined by the modified protocol. The responsive action may be a generation of a new message so as to ensure that the modified protocol is not violated. The new message may be generated to enforce an order between messages, a rate of messages, or the like. In some cases, the responsive action may be to log an event in the event log, so as to enable auditing and future analysis of the offending message. In some exemplary embodiments, the responsive action may be defined automatically. Additionally or alternatively, a suggestion for a responsive action may be provided to a user, which may accept, change or reject the suggestion. In some cases, different responsive actions may be defined for different violations of the modified protocol. In some cases, violations of the modified protocol may be handled differently than violations of the original protocol. As an example, a logged event may indicate whether the violation is of the protocol or modified protocol. In some exemplary embodiments, the responsive action may include communicating with another device, computer, agent, or the like to notify of the result. As an example, a notification may be transmitted to a centralized server which notifies IT members, who can research the issue to identify a malicious activity and respond accordingly.

On Step 240, the modified protocol may be enforced in the deployment environment of the concrete appliance. During enforcement of the modified protocol, the responsive action may be activated.

In some cases, in the same deployed environment, different concretization of the same generic appliance may be used. Each concrete appliance may be treated separately, so as to automatically generate a different modified protocols corresponding the different concrete appliances. Each of the different modified protocols may relate to different specifications and limitations represented therein. In some cases, the different concretizations may be the same concrete appliance (e.g., a phone-set of a same model), which differs in the deployment (e.g., connected using landline, utilizing an Radio Frequency (RF) of certain range, directly connected to a fax machine, or the like).

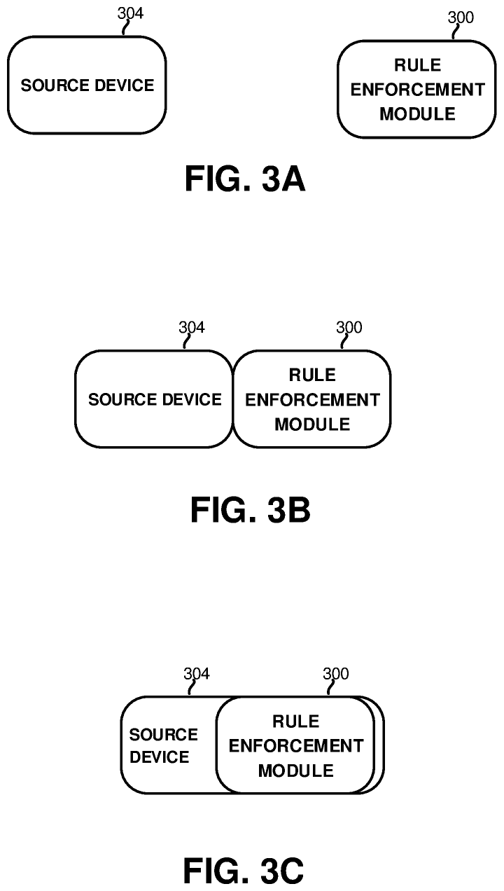

Referring now to FIGS. 3A-3C, demonstrating some exemplary embodiments for deployment of a system, in accordance with the disclosed subject matter.

FIG. 3A shows a block diagram of an embodiment in which rule enforcement module 300 is not part of any source device 304 in the system but is rather an independent unit intercepting messages transmitted by, or about to be received by, a multiplicity of devices. Rule enforcement module 300 can be implemented, for example, as a server to which all messages arrive for dispatching, and which can thus stop the dispatching of offending messages. A server in accordance with this configuration may have easier access to information related to different components of the network.

FIG. 3B shows a block diagram of an embodiment in which rule enforcement module 300 is an independent dedicated software or hardware device situated between source device 304 and any other device in the system, such that it can intercept messages transmitted to or by source device 304.

FIG. 3C shows a block diagram of an embodiment in which rule enforcement module 300 is implemented as part of source device 304. It will be appreciated that this embodiment may refer to rule enforcement module 300 being implemented independently of the main functionality of source device 304 such as an add-on software module executed by a processor of source device 304, or embedded within and performed as part of said functionality.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1-39. (canceled)

40. A computer-implemented method comprising:
obtaining a protocol, wherein the protocol is a user-defined communication protocol, wherein the protocol is utilized by a generic appliance;
obtaining a specification of a concrete appliance, wherein the specification is a computer-readable specification, wherein the concrete appliance is a concretization of the generic appliance, wherein the specification indicates one or more limitations of the concrete appliance which are not generic limitations applicable to the generic appliance; and
modifying the protocol based on the specification, whereby adjusting the protocol to comply with the one or more limitations of the concrete appliance.

41. The computer-implemented method of claim 40, wherein said modifying comprises: restricting values of one or more fields within a message in accordance with the specification.

42. The computer-implemented method of claim 41, wherein said restricting values comprises restricting values that are not supported by the concrete appliance.

43. The computer-implemented method of claim 41, wherein said restricting values comprises restricting values that are supported by the concrete appliance and are indicated by the specification as not recommended.

44. The computer-implemented method of claim 40, wherein said modifying comprises: enforcing a maximal rate of messages.

45. The computer-implemented method of claim 44, wherein the one or more limitations comprise a limitation of the concrete appliance to perform actions in response to the messages, wherein the maximal rate of messages is defined based on the limitation, wherein the limitation is based on a physical limitation of the concrete appliance on a rate of the actions.

46. The computer-implemented method of claim 44, wherein the one or more limitations comprise a limitation of the concrete appliance on a rate of receiving or processing messages, wherein the maximal rate of messages is defined based on the limitation.

47. The computer-implemented method of claim 40, wherein said modifying comprises: enforcing a minimal delay between two messages.

48. The computer-implemented method of claim 40, wherein the one or more limitations comprise a pre-condition on a state of the concrete appliance, wherein a processing of a message, by the concrete appliance, is conditioned on the pre-condition, wherein said modifying comprises: enforcing the pre-condition.

49. The computer-implemented method of claim 40, wherein the concrete appliance is configured to be deployed in an environment in which communication messages are transmitted to or from the concrete appliance based on the protocol.

50. The computer-implemented method of claim 40 further comprising: enforcing, in a deployment environment, the modified protocol, wherein the deployment environment comprises the concrete appliance.

51. The computer-implemented method of claim 50, wherein said enforcing comprises: generating a new message to comply with a minimal frequency requirement indicated in the specification.

52. The computer-implemented method of claim 40 further comprises defining a modification action to modify a message that complies with the protocol and does not comply with the modified protocol.

53. A computerized apparatus having a processor, the processor being adapted to perform the steps of:
obtaining a protocol, wherein the protocol is a user-defined communication protocol, wherein the protocol is utilized by a generic appliance;
obtaining a specification of a concrete appliance, wherein the specification is a computer-readable specification, wherein the concrete appliance is a concretization of the generic appliance, wherein the specification indicates one or more limitations of the concrete appliance which are not generic limitations applicable to the generic appliance; and
modifying the protocol based on the specification, whereby adjusting the protocol to comply with the one or more limitations of the concrete appliance.

54. The computerized apparatus of claim 53, wherein said modifying comprises: restricting values of one or more fields within a message in accordance with the specification, wherein said restricting values comprises restricting values that are not supported by the concrete appliance.

55. The computerized apparatus of claim 53, wherein said modifying comprises: enforcing a maximal rate of messages, wherein the one or more limitations comprise a limitation of the concrete appliance to perform actions in response to the messages, wherein the maximal rate of messages is defined based on the limitation, wherein the limitation is based on a physical limitation of the concrete appliance on a rate of the actions.

56. The computerized apparatus of claim 53, wherein said modifying comprises: enforcing a maximal rate of messages, wherein the one or more limitations comprise a limitation of the concrete appliance on a rate of receiving or processing messages, wherein the maximal rate of messages is defined based on the limitation.

57. The computerized apparatus of claim 53, wherein said modifying comprises: enforcing a minimal delay between two messages.

58. The computerized apparatus of claim 53, wherein the one or more limitations comprise a pre-condition on a state of the concrete appliance, wherein a processing of a message, by the concrete appliance, is conditioned on the pre-condition, wherein said modifying comprises: enforcing the pre-condition.

59. A computer program product comprising a non-transitory computer readable storage medium retaining program instructions, which program instructions when read by a processor, cause the processor to perform a method comprising:
obtaining a protocol, wherein the protocol is a user-defined communication protocol, wherein the protocol is utilized by a generic appliance;
obtaining a specification of a concrete appliance, wherein the specification is a computer-readable specification, wherein the concrete appliance is a concretization of the generic appliance, wherein the specification indicates one or more limitations of the concrete appliance which are not generic limitations applicable to the generic appliance; and
modifying the protocol based on the specification, whereby adjusting the protocol to comply with the one or more limitations of the concrete appliance.
